(19) United States
(12) Patent Application Publication
(10) Pub. No.: US 2024/0333493 A1
(43) Pub. Date: Oct. 3, 2024

(54) DATA SECURITY

(71) Applicant: BRITISH TELECOMMUNICATIONS PUBLIC LIMITED COMPANY, London (GB)

(72) Inventors: Fadi EL-MOUSSA, London (GB); Daniel BASTOS, London (GB)

(21) Appl. No.: 18/580,915

(22) PCT Filed: Jun. 29, 2022
(86) PCT No.: PCT/EP2022/067951

§ 371 Date: Jan. 19, 2024

(30) Foreign Application Priority Data
Jul. 23, 2021 (GB) 2110599.4

(51) Int. Cl. H04L 9/08

(52) U.S. Cl. CPC H04L 9/088

(57) ABSTRACT

A method comprising, at a processor-controlled device, obtaining encrypted data comprising an encrypted data portion, obtaining an identifier indicative of a characteristic associated with the processor-controlled device, and performing a decryption process. The decryption process comprises decrypting the encrypted data portion to generate a decrypted data portion, and generating decrypted data comprising the decrypted data portion and an identifying portion based on the identifier.

### TECHNICAL FIELD

The present invention relates to data security.

### BACKGROUND

The communication of data in computing systems is widespread. For example, as the number of Internet of Things (IoT) devices in use has increased, the data collected by and communicated with IoT device has correspondingly increased. Data, such as IoT data, can be personal, and represent private information that needs to be protected. For example, if a network log indicates that the volume of traffic transmitted by a particular IoT device increases at a certain time of the day, it could be inferred that the user is performing a particular activity, which involves use of the particular IoT device, at that time of the day. This can compromise the security of the environment in which the IoT device is located. For example, if the IoT device is located at a user's home, a malicious party may be able to infer when the user is likely to be out of their home, and hence when the home is more vulnerable to burglary.

Given these privacy concerns, various techniques can be used to improve data security, such as the encryption of data. However, despite the use of these measures, cyber-attacks on networks, and data transmitted via networks, are increasing. Cyber-attacks can involve a number of malicious actors, and it can be difficult to identify the origin of a particular attack and the entity or entities involved in the attack. This can, in turn, hamper attempts to take mitigating action to thwart attempted or ongoing attacks.

It is desirable to at least alleviate some of the aforementioned problems.

### SUMMARY

According to a first aspect of the present disclosure, there is provided a method comprising, at a processor-controlled device: obtaining encrypted data comprising an encrypted data portion; obtaining an identifier indicative of a characteristic associated with the processor-controlled device; and performing a decryption process comprising: decrypting the encrypted data portion to generate a decrypted data portion; and generating decrypted data comprising the decrypted data portion and an identifying portion based on the identifier.

In some examples, the encrypted data is indicative of at least one previous interaction with the encrypted data portion and/or an unencrypted version of the encrypted data portion. The at least one previous interaction may comprise a previous decryption of the encrypted data portion by a further processor-controlled device. The at least one previous interaction may also or instead comprise a previous generation of the unencrypted version of the encrypted data portion by a sensor device. In some of these examples, the method comprises decrypting at least a portion of the encrypted data to obtain at least one further identifier associated with the at least one previous interaction; and generating the identifying portion, comprising processing the identifier and the at least one further identifier using a one-way cryptographic function. In some of these examples, the method comprises decrypting at least a portion of the encrypted data to obtain at least one further identifier associated with the at least one previous interaction; and generating the identifying portion, wherein the identifying portion comprises the identifier and the at least one further identifier. The method may further comprise using a further identifier of the at least one further identifier to obtain, from storage of the processor-controlled device or a remote system, a characteristic associated with a device involved in a previous interaction of the at least one previous interaction. The characteristic associated with the device may be obtained in response to a determination that the previous interaction is indicative of malicious behaviour.

In some examples, decrypting the encrypted data portion comprises decrypting the encrypted data portion using a key based on at least part of an unencrypted version of the encrypted data.

In some examples, the method comprises encrypting the decrypted data using a key based on at least part of the decrypted data to obtain re-encrypted data, and optionally sending the re-encrypted data to a further processor-controlled device.

In some examples, the decryption process is performed using an application of the processor-controlled device. Decrypting the encrypted data portion may comprise decrypting the encrypted data portion using an application key associated with the application. The decrypted data may be encrypted using the application key. Decrypting the encrypted data portion may comprise decrypting the encrypted data portion using a combined key based on a combination of the application key and the key based on at least part of the unencrypted version of the encrypted data. The method may comprise encrypting the decrypted data using a combined key based on a combination of the application key and the key based on at least part of the decrypted data.

In some examples, obtaining the identifier comprises processing characteristic data indicative of the characteristic using a one-way cryptographic function to generate the identifier.

In some examples, the identifier is further indicative of a characteristic associated with the encrypted data portion.

According to a second aspect of the present disclosure, there is provided a method comprising, at a processor-controlled device: obtaining sensitive data; generating an identifier indicative of a characteristic associated with the processor-controlled device and/or a further processor-controlled device that previously interacted with the sensitive data; and performing an encryption process comprising generating encrypted data from which the identifier is derivable, the encrypted data comprising an encrypted data portion representative of the sensitive data.

In some examples, the sensitive data comprises an identifying portion indicative of at least one further previous interaction with the sensitive data and/or an encrypted version of the sensitive data.

In some examples, generating the encrypted data comprises generating the encrypted data using a key based on the sensitive data.

In some examples, the encryption process is performed using an application of the processor-controlled device. Generating the encrypted data may comprise generating the encrypted data using an application key associated with the application. Generating the encrypted data may comprise generating the encrypted data using a combined key based on a combination of the application key and the key based on the sensitive data.

In some examples, generating the identifier comprises processing characteristic data indicative of the characteristic using a one-way cryptographic function.

According to a third aspect of the present disclosure, there is provided a processor-controlled device comprising at least one processor and storage comprising computer program instructions which, when processed by the at least one processor, cause the processor-controlled device to perform the method of any examples in accordance with the first or second aspects of the present disclosure.

According to a fourth aspect of the present disclosure, there is provided a network comprising the processor-controlled device according to any examples in accordance with the third aspect of the present disclosure.

### BRIEF DESCRIPTION OF THE DRAWINGS

For a better understanding of the present disclosure, reference will now be made by way of example only to the accompany drawings, in which:

FIG. 1 is a flow diagram of a method comprising a decryption process according to examples;

FIG. 2 is a flow diagram of a method comprising an encryption process according to examples;

FIG. 3 is a schematic diagram showing a system for encryption and decryption of data according to examples;

FIG. 4 is a schematic diagram showing a method of encrypting and decrypting data according to examples;

FIG. 5 is a schematic diagram showing a method of encrypting and decrypting data according to further examples; and

FIG. 6 is a schematic diagram showing internal components of an example data processing system.

### DETAILED DESCRIPTION

Apparatus and methods in accordance with the present disclosure are described herein with reference to particular examples. The invention is not, however, limited to such examples.

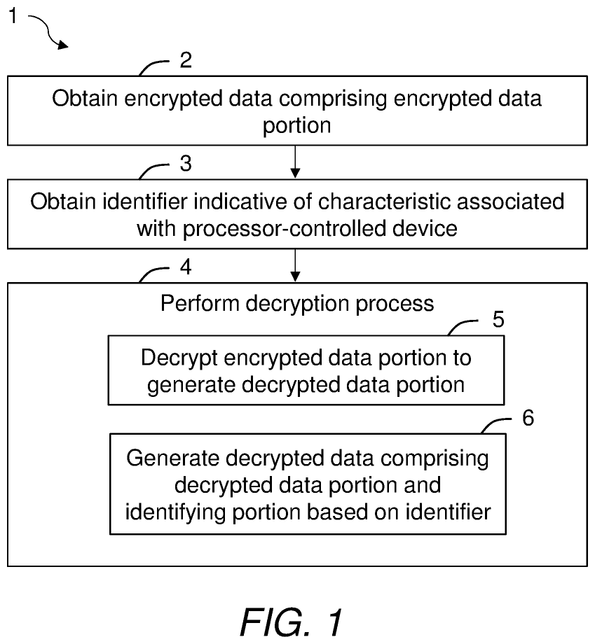

FIG. 1 is a flow diagram of a method 1 comprising a decryption process according to examples. Item 2 of the method 1 of FIG. 1 involves obtaining, at a processor-controlled device, encrypted data comprising an encrypted data portion, e.g. representing a measurement performed by a so-called Internet of Things (IoT) device. An identifier indicative of a characteristic associated with the processor-controlled device, e.g. an identity and/or location of the processor-controlled device, is also obtained at item 3 of the method 1. At item 4 of FIG. 1, a decryption process is performed, which includes, at item 5, decrypting the encrypted data portion to generate a decrypted data portion and, at item 6, generating decrypted data comprising the decrypted data portion and an identifying portion based on the identifier.

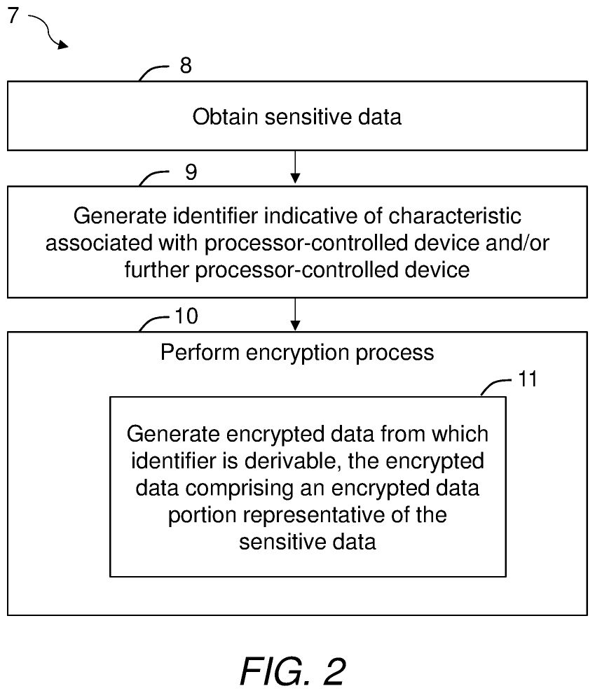

FIG. 2 is a flow diagram of a method 7 comprising an encryption process according to examples. Item 8 of the method 7 of FIG. 2 involves obtaining sensitive data, which in this example is to be encrypted using the encryption process. Item 9 of the method 7 involves generating an identifier indicative of a characteristic associated with a processor-controlled device performing the encryption process and/or a further processor-controlled device that previously interacted with the sensitive data. At item 10, an encryption process is performed, which involves, at item 11, generating encrypted data from which the identifier is derivable. The encrypted data includes an encrypted data portion representative of the sensitive data.

In the methods 1, 7 of FIGS. 1 and 2, the identifier or identifying portion acts as an electronic tag, e.g. similar to a watermark, allowing the decryption and/or encryption of the data by the processor-controlled device to be subsequently identified. This approach means that it is possible to track which device(s) have decrypted and/or encrypted the data. In the event of a data breach performed by a malicious device, this can be used to identify devices that have interacted with the data, from which the malicious device can be identified. This can act as a deterrent for malicious behaviour. Furthermore, by identifying malicious parties and their actions, appropriate mitigating action can be taken to secure the data or network or to reduce the risk of cyber-attacks by other malicious parties acting similarly.

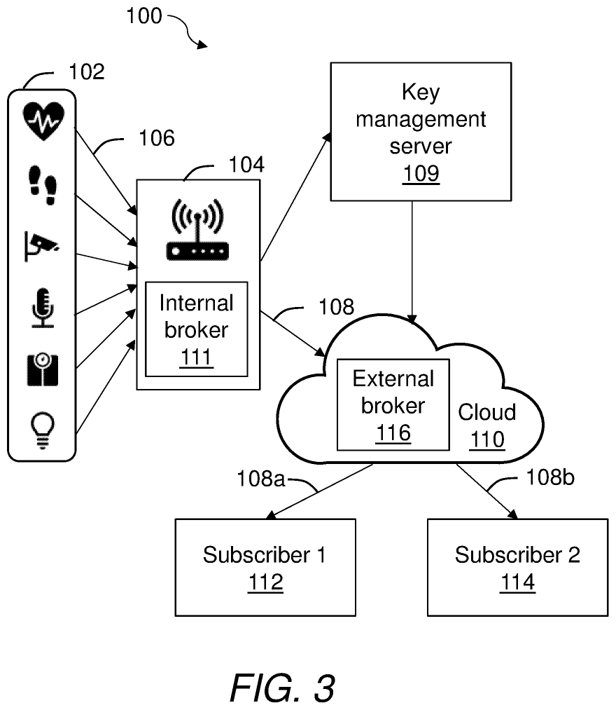

FIG. 3 is a schematic diagram showing a system 100 for encryption and decryption of data according to examples. The system 100 includes a plurality of user devices 102, which in this example are IoT devices. An IoT device is for example a device with the means to communicate data within its environment, e.g. over a network local to the environment. IoT devices can be included in the Internet of Things, which is a network of user devices such as home appliances, vehicles and other items embedded with electronics, software, sensors, actuators, and/or connectivity which enable these devices to connect with each other and/or other computer systems and exchange data. Examples of IoT devices include smart light bulbs, smart cameras, smart doorbells, connected refrigerators, smart televisions (TVs) and voice assistant devices.

In the system 100 of FIG. 3, the user devices 102 are in communication with a gateway 104, which involves the sending of data 106 (indicated in FIG. 3 by arrows from the user devices 102 to the gateway 104) to the gateway 104. For example, a given user device 102 may obtain a measurement or other data, which may be transmitted to a remote server for analysis or other processing. The data may for example represent string and/or text messages sent as part of an IoT protocol such as Message Queuing Telemetry Transport (MQTT), Constrained Application Protocol (CoAP), Advanced Message Queuing Protocol (AMQP) and so forth. Although not shown in FIG. 3, it is to be appreciated that the gateway 104 may be in two-way communication with respective user devices, and may therefore also send data to respective user devices. For example, in response to receiving data from a particular user device, a remote server may transmit instructions to the user device via the gateway 104. In FIG. 3, the data sent from the user devices 102 to the gateway 104 is unencrypted, but in other cases at least some data sent from a user device to a gateway may be encrypted.

The gateway 104 provides a network, which in this example is a local network, such as a home network. For example, the gateway 104 may be a home router, such as a home hub, of the home network, or another device to provide an entry point to the network or to filter and/or route network traffic, such as a switch, hub, access point or edge device (which may be or comprise a router or routing switch). The gateway 104 is an example of a processor-controlled device. However, it is to be appreciated that, in general, a processor-controlled device is for example any device controlled by a processor, such as a computer, e.g. a laptop computer, or a smartphone.

The user devices 102 are connected to the network provided by the gateway 104. The gateway 104 can be connected to a further network. The further network may be a single network or may include a plurality of networks. The further network may be or include a wide area network (WAN), a local area network (LAN) and/or the Internet, and may be a personal or enterprise network. In this case, the gateway 104 is connected to the Internet, and can hence send data to at least one remote system via the Internet. In FIG. 3, the gateway 104 is configured to encrypt the data received from a user device 102 before sending the encrypted data 108 to a cloud computing system 110 via the Internet. A key used to encrypt the data in this example is generated by the gateway 104 and then sent to a key management server 109 for storage. The cloud computing system 110 can then subsequently receive the appropriate key for decryption of encrypted data from the key management server 109, which it can communicate to a further computing device to which the encrypted data is to be sent.

The system 100 of FIG. 3 uses a publish/subscribe architecture for data exchange, in which senders of messages, referred to as publishers, publish messages to particular channels relating to specific topics (although other data exchange mechanisms are possible in other examples). In a publish/subscribe architecture, subscribers can subscribe to a particular channel if they are interested in receiving messages related to the topic that channel relates to. In the context of FIG. 3, to send the data from the user devices 102 to the cloud computing system 110, the user devices 102 act as publishers and the cloud computing system 110 acts as a subscriber. An internal broker 111 of the gateway 104 acts as an intermediary to route data to the cloud computing system 110 and to encrypt unencrypted data received from the user devices 102, so that unencrypted data is not sent unsecured via the Internet.

In FIG. 3, the cloud computing system 110 is configured to send the encrypted data received from the gateway 104 to a first subscriber 112 and a second subscriber 114. In this example, the user device 102 capturing data to be sent to the first and second subscribers 112, 114 is a fitness tracking bracelet, which measures a user's heart rate and temperature, and via which a user can enter their weight. The first subscriber 112 is a computing device associated with a hospital and the second subscriber 114 is a computing device associated with an insurance company. To send the encrypted data 108 from the cloud computing system 110 to the first and second subscribers 112, 114, an external broker 116 of the cloud computing system 110 acts as an intermediary between the internal broker 111 of the gateway 104 (which now acts as a publisher) and external entities, which in this case are the devices associated with the hospital and insurance company (which act as the first and second subscribers 112, 114).

For each type of data published, the internal and external brokers 111, 116 store a list of topics to which the data is published (e.g. temperature, heart rate, weight and so forth). The subscribers subscribe to topics of interest to them. So, for example, the first subscriber 112 (the hospital) may subscribe to the “Heart Rate” topic, and the second subscriber 114 (the insurance company) may subscriber to the “Weight” topic. This is shown schematically in FIG. 3, in which the encrypted data 108 sent from the gateway 104 to the cloud computing system 110 includes heart rate data representing the heart rate measurements obtained by the fitness tracking bracelet and weight data representing the weight measurements entered into the fitness tracking bracelet. The heart rate data 108a is published from the cloud computing system 110 to the first subscriber 112 (the hospital) and the weight data 108b is published from the cloud computing system 110 to the second subscriber 114 (the insurance company).

As explained above, examples herein involve embedding an identifier in encrypted and/or decrypted data that provides information relating to a processor-controlled device that has interacted with the data, e.g. by encrypting and/or decrypting the data. For example, the information (e.g. as represented by the identifier, which is indicative of a characteristic of the processor-controlled device and may also further indicate a characteristic associated with the data itself) may indicate how, where, and by whom the data was generated and/or accessed. The encrypted and/or decrypted data in which the identifier is embedded may then be stored, e.g. by the processor-controlled device or by a remote system such as the cloud computing system 110 or a further processor-controlled device (in which case the encrypted and/or decrypted data is sent to the remote system before storage).

Characteristics associated with a processor-controlled device may include:
An identity of the processor-controlled device (e.g. a subscriber device or sensor device) that interacted with the data, for example by generating, sensing or otherwise obtaining the data, or receiving, reading, encrypting or decrypting the data. For example, the identity may be indicated by a device identification code, type, manufacturer, location, and so forth.
An identity of an entity or user associated with the processor-controlled device, such as the identity of the hospital that owns a computing device to which the data is sent (e.g. entity name, type, location, market value, and so forth).
The time and/or date the data was interacted with by the processor-controlled device.

Characteristics associated with the data may include:
The topic the data was published to (e.g. a “Heart Rate” topic).
The owner of the data. For example, if the data represents personal data of a user, such as the heart rate of the user, the owner of the data may represent the identity of the user, which need not necessarily be the same as the identity of the owner of the user device that obtained the data, e.g. if the same user device is owned by one person but is used by multiple members of that person's household.
The time and/or date the data was generated, sensed or otherwise obtained.

At least one characteristic associated with the processor-controlled device, and in some cases at least one characteristic associated with the data, are used to produce the identifier, which can be embedded in data during encryption and/or decryption as a digital tag. In one example, the identifier is a hashed identifier, which has been obtained by processing characteristic data representing the at least one characteristic using a one-way cryptographic function, such as a hash function (e.g. Secure Hash Algorithm 256, SHA-256). As the skilled person will appreciate, a one-way cryptographic function is for example a function that is practically infeasible to invert or reverse, to prevent reverse engineering of the inputs to the function (which, in this case, are the at least one characteristic). A hash function takes a variable-length input (the at least one characteristic in this example) and converts it to a fixed-length output (the identifier, which in this case is a string). This process can be summarised by the following formula:

H(characteristic(s))=identifier

where H indicates the use of a hash function, characteristic(s) indicates at least one characteristic associated with at least the processor-controlled device (and in some cases at least one characteristic associated with the data to be interacted with), and identifier indicates the identifier generated.

In an example in accordance with the system 100 of FIG. 3, a user (“Alice”) wears the fitness tracking bracelet (“Bracelet”), which is one of the user devices 102, which senses the heart rate of the user, publishes data representing the heart rate to the “Heart Rate” topic to subscribers to that topic (which in this example include the cloud computing device 110) via the gateway 104, on the date 11/07/2020. In this example, unencrypted data representing the heart rate is obtained by the fitness tracking bracelet and is then sent to the gateway 104. The gateway 104 generates an identifier based on the characteristics associated with the fitness tracking bracelet and the heart rate data, as follows:

H(Bracelet, Heart Rate, 11072020, Alice)=e0ee8bb50685e05fa0f47ed04203ae953fdfd055f5bd2892ea186504254f8c3a

in which Bracelet indicates an identity of the fitness tracking bracelet, Heart Rate indicates that the fitness tracking bracelet is configured to publish heart rate data to the “Heart Rate” topic, 11072020 indicates a date on which the heart rate measurement was obtained, and Alice indicates the identity of a user of the fitness tracking bracelet.

In this example, Alice's heart rate is 80 beats per minute (80 bpm). The identifier and the heart rate are combined (e.g. by concatenation) to obtain data to be encrypted, which is for example sensitive data (e.g. personal or otherwise private data). In this case, the data to be encrypted is as follows:
e0ee8bb50685e05fa0f47ed04203ae953fdfd055f5bd2892ea186504254f8c3a 80 bpm

The data is then encrypted. In examples such as this, the data is encrypted using an application of a processor-controlled device (in this case, an application of the gateway 104). Use of an application for example allows a controlled environment to be provided for encryption and/or decryption of data, so that the encryption and/or decryption processes used are controlled by the provider or owner of the application, such as a system administrator. In some cases, data encrypted using the application can only be decrypted by an instance of the application (which may be instantiated on the same or a different device to that which originally encrypted the data). To achieve this, the data can be encrypted using an application key associated with the application. In this way, the usage of the encryption and/or decryption processes provided by the application, which involve the inclusion of an identifying portion in the encrypted and/or decrypted data generated, can be enforced, to provide for tracking of interactions with the data.

The application may use various cryptographic functions for encryption and decryption, e.g. symmetric key cryptography, such as the Advanced Encryption Standard (AES) 256 specification. If a symmetric key is used, the key is generated by the sender of the data (which is e.g. also the entity performing the encryption of the data, such as the gateway 104 in this example), rather than generating a key during a handshake process between two entities participating in the sending and receiving of the encrypted data. In examples, the key is generated using a one-way cryptographic function (e.g. a hash function), and may be a hash key generated for example using the SHA-256 or SHA-512 standards. In such examples, the key may depend on at least part of the data to be encrypted (and, in some cases, also on an application key associated with an application used to perform the encryption) rather than re-using the same key to encrypt multiple sets of data. This approach can reduce the likelihood of a malicious party gaining access to the key and being able to decrypt the data.

In the example of FIG. 3, the following functions are used:

SHA256(input data)=hash output

where SHA256 indicates the use of the SHA-256 hash function,

AES256_enc(encryption key, plaintext data)=encrypted data

where AES256_enc indicates the use of the AES-256 standard to perform encryption, and

AES256_dec(encryption key, encrypted data)=plaintextdata

where AES256_dec indicates the use of the AES-256 standard to perform the decryption.

In the example of FIG. 3, encryption is performed by an application of the gateway 104, which may be implemented by the internal broker 111 of the gateway 104. During encryption, a key is generated by processing the data to be encrypted using the SHA-256 hash function, as follows:

SHA256(e0ee8bb50685e05fa0f47ed04203ae953fdfd055f5bd2892ea186504254f8c3a80 bpm) =69A7D61C061B09998F88C7B028A2446B66054A07E0F453A618E66E1DDE7B7603

This generates the key:

69A7D61C061B09998F88C7B028A2446B66054A07E0F453A618E66E1DDE7B7603

which is then used to encrypt the data, using AES-256 encryption. During encryption, an application key associated with the application (which may be referred to as an application secret, and is for example a random string) is added to the key to ensure that decryption of the encrypted data is only possible within the application. The encryption is performed as follows:

AES256_enc(69A7D61C061B09998F88C7B028A2446B66054A07E0F453A618E66E1DDE7B7603+application secret,e0ee8bb50685e05fa0f47ed04203ae953fdfd O55f5bd2892ea186504254f8c3a80 bpm)=DSHWAQK09jgW6MtVIP3cFj7CsNfevoQLQQSr/6zmdUODIWh1jE++8rwHS5I7AU8ZG+IbMrapNiEeBUgXCkwDmOizvZFbfSh5pO5PQGCZfqU=

where the encrypted data represents everything after the first equals sign in the formula above, starting with the letter “D” and ending with an equals sign “=”.

The encrypted data is then sent to subscribers who subscribe to the topic “Heart Rate”. In FIG. 3, the first subscriber 112 (which is a computing device associated with a hospital) subscribes to this topic, and hence receives the encrypted data from the gateway 104, via the cloud computing system 110. In examples such as this, the encrypted data is indicative of at least one previous interaction with an encrypted data portion of the encrypted data and/or an unencrypted version of the encrypted data portion. In this case, the encrypted data portion is the encrypted data itself. However, in other examples, the encrypted data portion may be less than all of the encrypted data. In this case, the identifier (which in this example is based on the characteristics associated with the fitness tracking bracelet and the heart rate data) is derivable from the encrypted data. As the fitness tracking bracelet originally generated the data that was encrypted to generate the encrypted data, the encrypted data is indicative of a previous generation of an unencrypted version of the encrypted data portion by a sensor device (the fitness tracking bracelet). However, this is merely an example. In other cases, the at least one previous interaction indicated by the encrypted data may include a previous decrypted version of the encrypted data portion by a further processor-controlled device. For example, a set of previous interactions with the encrypted data portion and/or an unencrypted version of the encrypted data portion may be derivable from the encrypted data, so that the entities that have interacted with the data and/or the actions performed by these entities, can be identified. As explained above, this for example allows potentially malicious entities and/or actions to be identified in the event of a data breach.

In FIG. 3, the first subscriber 112 receives the encrypted data 108a and performs a decryption process as explained above. In this case, the first subscriber 112 is running an instance of the same application used by the gateway 104 to encrypt the data, and uses the application to perform the decryption process. This involves decrypting the encrypted data portion (which in this case corresponds to the encrypted data 108a) to generate a decrypted data portion, and generating decrypted data including the decrypted data portion and an identifying portion based on an identifier indicative of a characteristic associated with the first subscriber 112. The decrypted data in this case is indicative (in this case by virtue of the identifying portion of the decrypted data) that the encrypted data portion has been decrypted by the first subscriber 112.

For example, the decrypted data may be unique to the first subscriber 112, allowing the identity of the first subscriber 112 to be obtained from the decrypted data.

In this example, the identifier associated with the first subscriber 112 is obtained in a similar manner to that used to obtain the identifier associated with the gateway 104 (which may be referred to as a further identifier), by applying a one-way cryptographic function (in this case, a hash function) to characteristics associated with the first subscriber 112 and the data, as follows:

SHA256(Heart rate, Ipswich Hospital, Suffolk) =2439c1220d10cab63f761cccdca5183fcbf643d58edcb28f293cd9df40fae4cd

where Heart Rate indicates that the first subscriber 112 subscribes to the topic “Heart Rate”, Ipswich Hospitalindicates that the first subscriber 112 is a device associated with Ipswich Hospital and Suffolk indicates that the first subscriber 112 is a device located in Suffolk.

The encrypted data is decrypted using the key used to encrypt it (as, in this case, a symmetric cryptographic protocol is used), as follows:

AES256_dec(69A7D61C061B09998F88C7B028A2446B66054A07E0F453A618E66E1DDE7B7603+application secret,DSHWAQK09jgW6MtV1P3cFj7CsNfevoQLQQSr/6zmdUODlWh1jE++8rwHS 5I7AU8ZG+IbMrapNiEeBUgXCkwDmOizvZFbfSh5pO5PQGCZfgU=) =6121b42494ebc5ffcf73723016e73382db0bf8d8a5dd6fe5afe12e4ec3dfa273 80 bpm

where the encrypted data represents everything after the comma in the expression for “AES256_dec”, starting with the letter “D” and ending with an equals sign “=”.

In this example, the decryption uses a key based on at least part of an unencrypted version of the encrypted data, which key is as follows:
69A7D61C061B09998F88C7B028A2446B66054A07E0F453A618E66E1DDE7B7603

In this case, the key is obtained by hashing the original data to be encrypted, and may be referred to as a first key. In this example, the decryption process also uses an application key associated with the application (referred to above as the application secret). In this case, the first key and the application have been combined (in this example by concatenation) to obtain a first combined key, which is used as the key for the decryption using the AES-256 standard. However, this is merely an example and, in other examples, the decryption process may use a different key, e.g. a key based on solely one of the first key or the application key. The key used to perform the decryption process may then be destroyed or discarded after use.

In this example, the decrypted data includes an identifying portion based on the identifier associated with the first subscriber 112 and the identifier associated with the gateway 104 (referred to as the further identifier), which is as follows:
6121b42494ebc5ffcf73723016e73382db0lbf8d8a5dd6fe5afe12e4ec3dfa273
   as well as a decrypted data portion, which in this case represents the original heart rate measurement of 80 bpm.

In this example, the decryption process involves decrypting the encrypted data using the combined key as an input to the AES-256 standard to obtain the decrypted data portion and the further identifier, before then generating the identifying portion based on the identifier and the further identifier.

As can be seen, the identifier represented by the identifying portion is different from both the further identifier, which is:
e0ee8bb50685e05faOf47edO4203ae953fdfdO55f5bd2892ea186504254f8c3a
   and the identifier, which is:
2439c1220d10cab63f761cccdca5183fcbf643d58edcb28f293cd9df40fae4cd

In this example, the identifier represented by the identifying portion is obtained by decrypting at least a portion of the encrypted data to generate at least one further identifier associated with the at least one previous interaction (in this case, the further identifier above, which is indicative of a the generation of the data by the fitness tracking bracelet), and processing the identifier and the further identifier using a one-way cryptographic function (in this case, a hash function), to generate the identifying portion as follows:

SHA256(e0ee8bb50685e05faOf47ed04203ae953fdfd055f5bd2892ea186504254f8c3a2439c1: 20d10cab63f761cccdca5183fcbf643d58edcb28f293cd9df40fae4cd) =6121b42494ebc5ffcf73723016e73382db0bf8d8a5dd6fe5afe12e4ec3dfa273

In other words, in this example, the identifying portion represents a hash of the identifier and the further identifier.

In the example of FIG. 3, the application of the first subscriber 112 then encrypts the decrypted data using a key based on at least part of the decrypted data itself, which may be referred to as a second key. The encryption performed by the first subscriber 112 may be considered to be a re-encryption of the data, to generate re-encrypted data. The re-encrypted data may be stored by the processor-controlled device and/or sent to a further processor-controlled device. The second key is generated by processing the identifier, the at least one further identifier (in this case, the further identifier as there is only one previous interaction with the data), and the part of the decrypted data corresponding to the original measurement using a one-way cryptographic function (in this case a hash function) as follows:

SHA256(e0ee8bb50685e05fa0f47ed04203ae953fdfd055f5bd2892ea186504254f8c3a 2439c1220d10cab63f761cccdca5183fcbf643d58edcb28f293cd9df40fae4cd80 bpm)=OCAAOD4DCA9EOFB5BEE3D78B52667DCDC2A428AA4DOBF2DBAFA14BEEOFA9C186

The identifier, the further identifier and the original data are sorted by date of access and combined (in this case by concatenation) before being hashed to generate the second key, whereas the identifying portion corresponds to a hash of the identifier and the further identifier (sorted by date of access and then concatenated before being hashed). This allows the second key to be generated using a stored set of identifiers for each of the interactions the data has been subjected to (e.g. a list of each of the identifiers such as a hash list if each of the identifiers is a hashed identifier), in combination with the original data. For example, the identifiers may be stored at the processor-controlled device or at a remote system, such as the cloud computing system 110 or the key management server 109, and made accessible for encryption and decryption of data. For example, the stored identifiers may be obtainable from the processor-controlled device or the remote system by the application, where the application is used to perform encryption and/or decryption. As the identifier and the further identifier are hashed to generate the identifying portion in this example, the message itself has a fixed size throughout its lifecycle, irrespective of the number of entities that interact with the message (and hence the number of identifiers that are concatenated before hashing). In other examples, though, the second key may be generated differently. For example, the second key may be a hash of the decrypted data (e.g. obtained by processing a combination of the original data and a hash of the identifier and the further identifier using a one-way cryptographic function).

As the encryption in this example occurs within the application, the encryption also uses an application key associated with the application, as follows:

AES256_enc(OCAAOD4DCA9EOFB5BEE3D78B52667DCDC2A428AA4DOBF2DBAFA14BEEOFA9C186+application secret,6121b42494ebc5f fcf73723016e73382db0lbf8d8a5dd6fe5afe12e4ec3dfa273 80 bpm)=mwfv9BkmLMR8inz2w5DZ/MFlu671+P3t1kurKORBb5t1D2CXyTyjjZ2WX OFJMgkbGEiO/RIzt3thnqF6xWONr6tMw3Yfy0/jnOOd/A/AbOw=

where the re-encrypted data represents everything after the first equals sign in the formula above, starting with the letter “m” and ending with an equals sign “=”.

In this case, the encryption (which in this case is a re-encryption) is performed using a second combined key based on a combination of the application key and the second key (which in this case are combined by concatenation, although this is merely an example).

As the second key depends on the identifier(s) associated with previous interactions with the data, an attempt to remove one of these identifiers during encryption (e.g. to hide the identity of a malicious party that accessed the data) will lead to a third party being unable to correctly decrypt the encrypted data due to use of an incorrect key. For example, the application may store a record of each of the identifiers as they are generated and used to encrypt and/or decrypt the data, and may then use these identifiers to generate a suitable key (in this case, the second key) for use in decryption of encrypted data received. If the malicious party attempts to encrypt data using a key that omits one of these identifiers, the application will generate a key that does not match the key used by the malicious party and will hence be unable to decrypt the encrypted data (thus indicating that the encrypted data has potentially been tampered with). Conversely, a third party with access to the key used by the malicious party will be unable to decrypt the encrypted data outside the application, as they will lack access to the application key. This approach therefore improves the security of the encryption and decryption process. It is to be appreciated, though, that in other examples a different key may be used to perform the encryption, such as solely one of the second key or the application key.

The re-encrypted data generated by this process hence includes information about the fitness tracking bracelet that originally generated the data as well as information about the first subscriber that accessed the data (and, in this case, decrypted the data). This process can be performed repeatedly, each time an entity encrypts or decrypts the data, in order to track interactions with the data over time.

Identifiers associated with each respective interaction with the data is for example stored at the processor-controlled device or a remote system, e.g. in the cloud computing system 110 or the key management server 109, and then used to track interactions with the data. For example, a further identifier may be used to obtain, from storage of the processor-controlled device or the remote system, a characteristic associated with a device involved in a previous interaction, e.g. allowing the device to be identified. For example, it may be determined by the processor-controlled device or the remote system that the previous interaction is indicative of malicious behaviour (e.g. by analysing data representing the previous interaction using intrusion detection techniques as the skilled person will appreciate). The characteristic associated with the device may then be obtained in response to determining that the previous interaction is indicative of malicious behaviour. Appropriate mitigating action may then be taken to mitigate the effect of the malicious behaviour. As an example, if the identifying portion is representative of a hashed identifier (where a hashed identifier may be understood to refer to an identifier obtained using a one-way cryptographic function such as a hash function), a hash value indicative of a characteristic associated with a device involved in a previous interaction with the data may be obtained (e.g. from a hash list stored at the remote system) and then compared with the hashed identifier to identify the device involved in the previous interaction. In such cases, the hash list may further indicate the underlying characteristics associated with a particular hash value, in order to allow these characteristics to be ascertained, or these characteristics may be obtained e.g. using publicly available information indicating a relationship between particular characteristics and corresponding hash values.

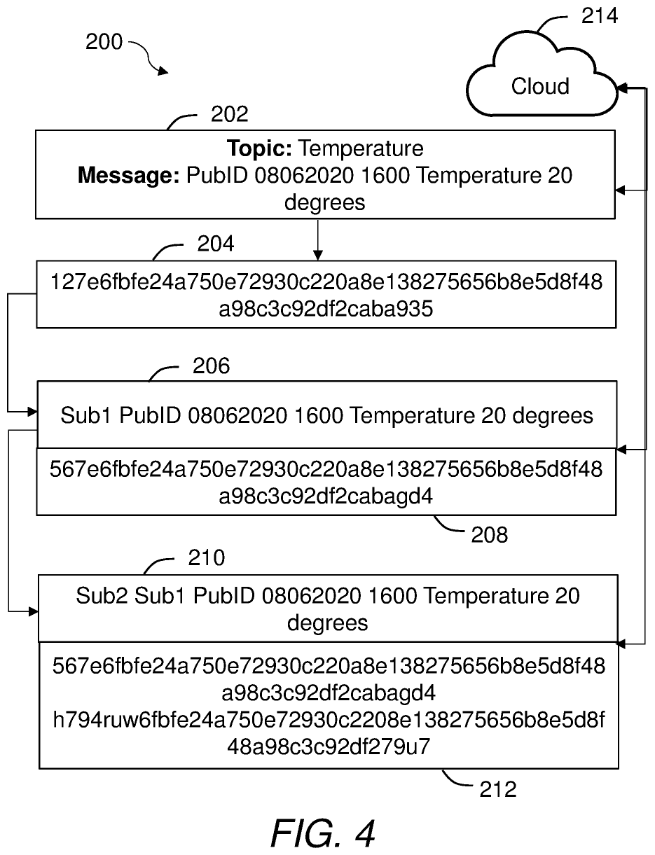

In this example, the identifying portion corresponds to a hash of the identifier and at least one further identifier. However, in other examples, the identifier and at least one further identifier need not be combined in this way to form the identifying portion. For example, in other examples the identifying portion may include the identifier and the at least one further identifier themselves, as explained further below with reference to FIG. 4. For example, encrypted data may be generated as explained with reference to FIG. 3, and then decrypted as follows:

AES256_dec(69A7D61C061B09998F88C7B028A2446B66054A07E0F453A618E66E1DDE7B7603+application secret,DSHWAQK09jgW6MtVIP3cFj7CsNfevoQLQQSr/6zmdUODlWh1jE++8rwHS 5I7AU8ZG+IbMrapNiEeBUgXCkwDmOizvZFbfSh5pO5PQGCZfgU=)=e0ee8bb50685e05faOf47ed04203ae953fdfdO55f5bd2892ea186504254f8c3a,2439c1220d10cab63f761cccdca5183fcbf643d58edcb28f293cd9df40fae4cd80bpm

where the encrypted data to be decrypted represents everything after the comma in the expression for “AES256_dec”, starting with the letter “D” and ending with an equals sign “=”.

In this further example, the output of the decryption process is different from that obtained in the previous example. Instead of obtaining decrypted data of a fixed size, a hash list of each of the identifiers associated with previous interactions with the data (which in this case, includes the identifier and the further identifier) is included as the identifying portion of the decrypted data. With this approach, storage of hashed identifiers is not needed, since the identifiers themselves can be obtained from identifying portion of the decrypted data. However, in this example, the decrypted data no longer has a fixed size, and will grow in size incrementally each time it is encrypted or decrypted (i.e. each time a new identifier is added to the identifying portion).

In this case, the decrypted data is re-encrypted using a key based on at least part of the decrypted data, which is the same as the second key of the previous example, and is generated as follows:

SHA256(e0ee8bb50685e05fa0f47ed04203ae953fdfd055f5bd2892ea186504254f8c3a 2439c1220d10cab63f761cccdca5183fcbf643d58edcb28f293cd9df40fae4cd80 bpm)=OCAAOD4DCA9EOFB5BEE3D78B52667DCDC2A428AA4DOBF2DBAFA14BEEOFA9C186

The second key is then used to re-encrypt the decrypted data as follows:

AES256_enc(OCAAOD4DCA9EOFB5BEE3D78B52667DCDC2A428AA4DOBF2DBAFA14BEEOFA9C186+application secret,e0ee8bb50685e05fa0f47ed04203ae953fdfd055f5bd2892ea186504254f8c3a 2439c1220d10cab63f761cccdca5183fcbf643d58edcb28f293cd9df40fae4cd80 bpm)=H6Ab6u1Z2fpOU2NKF9h5z7NJ+24Lm3X8Ctoo/zdCLHkH129SDFaBT+56H4PNV18cHOmE5x/r4ph 7mpmWK6lyAtgZ2+yWKTtoU7pGBZyA1YGxQgnspsBP/fTh9+b5RJkDXMjcdO6k/BoSviFfl5oA V/M Y9wERtwl/OHJeTIY7QT2sfBesdfngiCVhlmke05r8

where the re-encrypted data represents everything after the first equals sign in the formula above, starting with the letter “H” and ending with the number “8”.

As for the previous example, the re-encryption is performed within the application of the first subscriber 112, and uses an application key associated with the application (referred to above as the application secret), which is combined with the second key (in this case by concatenation) to generate a second combined key. The second combined key is used as an input to the AES-256 encryption process. Use of the application key ensures that decryption of the re-encrypted data can only be performed within an environment with access to the application key (e.g. an instance of the application).

The identifier, further identifier and original data are obtainable from the re-encrypted data (by decrypting the re-encrypted data), allowing the gateway 104 and the first subscriber 112 to be identified. In this example, identifiers associated with respective interactions need not be stored in order to allow the identity of a device associated with a particular interaction to be determined, as the identifiers can be obtained from the re-encrypted data itself. In this case, the identifier and the further identifier correspond to hashes of characteristics associated with different interactions respectively. The underlying (unhashed) information about these interactions can be obtained based on a public hash list indicating the relationship between unhashed characteristic values and corresponding identifiers (e.g. as represented by respective hash values). Such a hash list can for example be embedded in the data itself, included in metadata associated with the data and/or stored in a publicly-accessible storage system.

FIG. 4 is a schematic diagram showing a method 200 of encrypting and decrypting data, to put the examples described with reference to FIG. 3 into context. In the example of FIG. 4, subscribers to a particular topic are trusted subscribers and are therefore trusted to have access to information about interactions with the data. In the method 200 of FIG. 4, a publisher publishes a message 202 to the topic “Temperature”. The message 202 is as shown in FIG. 4 and includes a publisher ID (“PubID”, which is for example an identification code indicating the identity of the publisher device, which may be considered to be an identifier indicative of a characteristic of the publisher device), a date on which a temperature measurement is performed (“08062020”), a time at which the temperature measurement is published (“1600”), a topic to which the data is published (“Temperature”) and the temperature measurement itself (“20 degrees”). The publisher is for example a gateway, such as the gateway 104, which has received the message 202 in an unencrypted format from an IoT device that obtained the temperature measurement. The publisher ID, date, time and topic portions of the message 202 each correspond to a characteristic associated with the publisher or the data to be encrypted by the publisher, and are indicative of an interaction with the temperature measurement (in this case, the publication of the temperature measurement). The publisher ID, date, time and topic portions of the message 202 together correspond to an identifying portion of the message 202. The temperature measurement corresponds to the data to be encrypted.

The message 202 (which includes the publisher ID, which is an example of an identifier associated with the publisher) is encrypted to generate an encrypted message 204 (which is an example of encrypted data, and in this example is “127e6fbfe24a750e72930c220a8e138275656b8e5d8f48a98c3c92df2caba935”). The message 202 is encrypted using a key which corresponds to a hash of a concatenation of, firstly, a hash of the identifying portion and, secondly, the temperature measurement. The hash of the identifying portion in this case is sent to a cloud computing system 214 by the publisher for use in tracking interactions with messages including the temperature measurement (indicated schematically in FIG. 4 using a double-headed arrow between the cloud computing system 214 and the message 202). The stored identifying portion associated with the publisher can also be used to generate subsequent keys for the encryption of messages including the temperature measurement. In this example, the key itself is also stored in the cloud computing system 214, which can distribute the key to subscribers wishing to decrypt the encrypted message 204. In this case, the cloud computing system 214 performs the functions of both the cloud computing system 110 and the key management server 109 of FIG. 3. However, in other examples, the key management server 109 may be a separate system and may be used to store keys instead of the cloud computing system 214.

The encrypted message 204 is then sent to a first subscriber. The first subscriber decrypts the encrypted message 204 to generate a first decrypted message 206 which includes the original message 202 (including the publisher ID, the remaining characteristics of “08062020 1600 Temperature” and the original temperature measurement of “20 degrees”) as well as an identifier indicative of at least one characteristic of the first subscriber (the “Sub1” portion of the first decrypted message 206 shown in FIG. 4, which e.g. indicates an identity of the first subscriber). To decrypt the encrypted message 204, the first subscriber obtains the key used by the publisher to encrypt the message 202 from the cloud computing system 214 (indicated schematically in FIG. 4 using a double-headed arrow between the cloud computing system 214 and the first decrypted message 206 and first metadata 208 generated by the first subscriber). In other cases, though, the key may be sent from the publisher directly to the first subscriber. The first subscriber then uses the key to decrypt the encrypted message 204. The decrypted portion of the original message 202 corresponding to the temperature measurement may be taken to correspond to a decrypted data portion, with the remainder of the first decrypted message 206 corresponding to an identifying portion (which includes identifying portions associated with the publisher and first subscriber).

A hash of the identifier (“Sub1”) associated with the first subscriber (“567e6fbfe24a750e72930c220a8e138275656b8e5d8f48a98c3c92df2cabagd4” in this example) is generated as first metadata 208 associated with the first decrypted message 206. The first metadata 208 in this example is sent to the cloud computing system 214, which then stores the hash of the identifier associated with the first subscriber in storage. For example, the hash of the identifier associated with the first subscriber may be added to a hash list that also includes the hash of the identifying portion associated with the publisher. The hash list can then be synchronised with other instances of the application (e.g. an instance of the application running on the first subscriber device), and used by these other instances of the application to track previous interactions with the data and/or to encrypt data. In this case, the first decrypted message 206 is re-encrypted using a key based on the hash list (e.g. corresponding to a concatenation of the hashes of the identifier associated with the first subscriber and the identifying portion associated with the publisher) and the temperature measurement itself, which key is combined with an application key to generate a first combined key (which is used to perform the re-encryption). The first combined key is then sent to the cloud computing system 214 for distribution to other entities wishing to decrypt the re-encrypted version of the first decrypted message 206.

After the encrypted message 204 has been sent to the first subscriber, a re-encrypted version of the first decrypted message 206 is then sent from the first subscriber to the second subscriber. In other examples, though, the re-encrypted version of the first decrypted message 206 may instead be sent to the second subscriber from a different entity than the first subscriber, such as the publisher or a further computing system. Similarly to the first subscriber, the second subscriber decrypts the re-encrypted message using the first combined key, which is e.g. obtained from the cloud computing system 214 or from the first subscriber, to generate a second decrypted message 210. In this case, though, the second decrypted message includes the first decrypted message 202 (including the identifying portion associated with the publisher and the identifier indicative of at least one characteristic of the first subscriber), as well as an identifier indicative of at least one characteristic of the second subscriber (indicated as “Sub2”). A concatenation of a hash of the identifier associated with the first subscriber and a hash of the identifier associated with the second subscriber (which in this case is “h794ruw6fbfe24a750e72930c2208e138275656b8e5d8f48a98c3c92df279u7”) is generated as second metadata 212 associated with the second decrypted message 210. As described above for the first metadata 208, the second metadata 212 is sent to the cloud computing system 214 for storing in the hash list, which can then be used to re-encrypt the second decrypted message 210 similarly to re-encryption of the first encrypted message 206 (and/or for tracking of interactions with various versions of the original message 202).

Hence, in FIG. 4, as the subscribers are trusted, a cleartext identifier of the subscribers that have accessed the message (or an encrypted or decrypted version of the message) is included in an identifying portion of the message (which may be referred to as a digital tag of the message). This is indicated in FIG. 4 as “Sub1” and “Sub2” for the identifiers associated with the first and second subscribers, respectively. This allows a new subscriber to check who accessed the message previously.

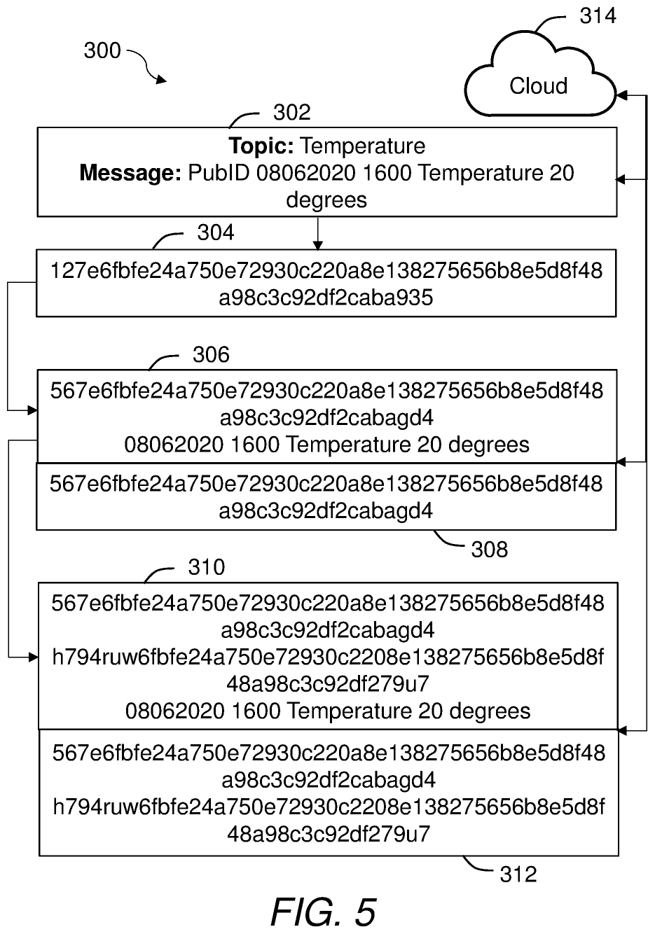

FIG. 5 is a schematic diagram showing a method 300 of encrypting and decrypting data according to examples. The method 300 of FIG. 5 is similar to the method 200 of FIG. 4 and corresponding features are labelled with the same reference numeral incremented by 100; corresponding descriptions are to be taken to apply. However, in contrast to FIG. 4, the subscribers are untrusted in FIG. 5, so the cleartext identifier of each subscriber is not included in the decrypted data. The subscribers of FIG. 5 are trusted to obtain the cleartext identifying portion associated with the publisher but in other examples this may not be the case, in which case the identifying portion associated with the publisher may be obfuscated, e.g. by processing this portion using a one-way cryptographic function.

In FIG. 5, the same message 302 as the message 202 of FIG. 4 is encrypted to generate an encrypted message 304. The identifying portion associated with the publisher (which is the same as that discussed with reference to FIG. 4) is hashed and sent to a cloud computing system 314, as is the key used to encrypt the message 302 (which is the same as the key used to encrypt the message 202 of FIG. 4). The encrypted message 304 is sent to a first subscriber, who obtains the appropriate key from the cloud computing system 314 and decrypts the encrypted message 304 to generate a first decrypted message 306. However, in FIG. 5, the decryption process involves generating a hash of an identifier indicative of at least one characteristic of the first subscriber, rather than an unhashed (i.e. cleartext) identifier. Hence, the first decrypted message 306 includes, as the identifying portion, a combination (e.g. a concatenation) of the identifying portion associated with the publisher (“PubID 08062020 1600 Temperature”), a hash of the identifier associated with the first subscriber (“567e6fbfe24a750e72930c220a8e138275656b8e5d8f48a98c3c92df2cabagd4”) and, as the decrypted data portion, the temperature measurement itself (“20 degrees”). However, like the example of FIG. 4, the hash of the identifier associated with the first subscriber is stored as first metadata 308 associated with the first decrypted message 306 and is sent to the cloud computing system 314 for use in subsequent encryption and/or tracking of messages as described above with reference to FIG. 4.

The first decrypted message 306 is then re-encrypted in the same manner as the re-encryption of the first decrypted message 206 of FIG. 4, and the key used to perform the re-encryption is sent from the first subscriber to the cloud computing system 314. The re-encrypted version of the first decrypted message 306 is then sent to the second subscriber. The second subscriber decrypts the first decrypted message 306 using the appropriate key (e.g. obtained from the cloud computing system 314 or directly from the first subscriber) to generate a second decrypted message 310, which includes, as the identifying portion, a combination (e.g. a concatenation) of the identifying portion associated with the publisher (“PubID 08062020 1600 Temperature”), a hash of the identifier associated with the first subscriber (“567e6fbfe24a750e72930c220a8e138275656b8e5d8f48a98c3c92df2cabagd4”) and a hash of the identifier associated with the second subscriber (“h794ruw6fbfe24a750e72930c2208e138275656b8e5d8f48a98c3c92df279u7”) and, as the decrypted data portion, the temperature measurement itself (“20 degrees”). Like the example of FIG. 4, the hashes of the identifiers associated with the first and second subscribers are stored as second metadata 312 associated with the second decrypted message 310 and the second metadata 312 is sent to the cloud computing system 314 for use in subsequent encryption and/or tracking of messages as described above with reference to FIG. 4. Each of the first and second decrypted messages 306, 310 hence includes identifiers indicative of characteristics associated with respective devices that accessed the first and second decrypted messages 306, 310 respectively, allowing access to the message 302 (from which the first and second decrypted messages 306, 310 are derived) to be tracked. For example, the cloud computing system 314 may further store the unhashed identifiers associated with the first and second subscribers, e.g. as part of the hash list, in a manner that allows the unhashed identifier corresponding to a particular hashed identifier to be determined. This for example allows unhashed identifiers to be obtained in the event of a data breach, e.g. by identifying the hashed identifier associated with a suspicious interaction associated with the data breach and then using the hash list stored in the cloud computing system 314 to identify the unhashed identifier corresponding to a particular hashed identifier.

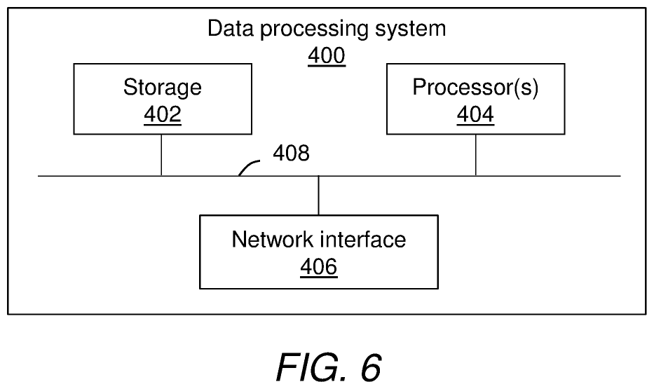

FIG. 6 is a schematic diagram of internal components of a data processing system 400 that may be used in any of the methods described herein. The data processing system 400 may include additional components not shown in FIG. 6; only those most relevant to the present disclosure are shown. The data processing system 400 may be or form part of a processor-controlled device (e.g. a gateway), a remote system or a further computing system. The data processing system 400 in FIG. 6 is implemented as a single computer device but in other cases a data processing system may be implemented as a distributed system.

The data processing system 400 includes storage 402 which may be or include volatile or non-volatile memory, read-only memory (ROM), or random access memory (RAM). The storage 402 may additionally or alternatively include a storage device, which may be removable from or integrated within the data processing system 400. For example, the storage 402 may include a hard disk drive (which may be an external hard disk drive such as a solid state disk) or a flash drive. The storage 402 is arranged to store data, temporarily or indefinitely. The storage 402 may be referred to as memory, which is to be understood to refer to a single memory or multiple memories operably connected to one another.

The storage 402 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The data processing system 400 also includes at least one processor 404 which is configured to implement the methods described herein. The at least one processor 404 may be or comprise processor circuitry. The at least one processor 404 is arranged to execute program instructions and process data. The at least one processor 404 may include a plurality of processing units operably connected to one another, including but not limited to a central processing unit (CPU) and/or a graphics processing unit (GPU). For example, the at least one processor 404 may cause the methods to be implemented upon processing suitable computer program instructions stored in the storage 402.

The data processing system 400 further includes a network interface 406 for connecting to at least one network, such as the local network and the Internet discussed with reference to FIG. 3. A data processing system otherwise similar to the data processing system 400 of FIG. 6 may additionally include at least one further interface for connecting to at least one further component. The components of the data processing system 400 are communicably coupled via a suitable bus 408.

Further examples relate to a computer-readable medium storing thereon instructions which, when executed by a computer, cause the computer to carry out the method of any of the examples described herein.

In the examples above, the data to be encrypted (which is e.g. sensitive data) is data obtained by an IoT device. However, it is to be appreciated that the methods and systems described herein may be used to encrypt and/or decrypt various other forms of data.

It is described above that a further identifier may be used to obtain a characteristic associated with a device involved in a previous interaction with data, e.g. to identify a device involved in a malicious interaction. It is to be appreciated that any of the identifiers of the examples above, which are e.g. embedded in decrypted or encrypted data may similarly be used to obtain, from storage of a processor-controlled device performing the encryption or decryption or a remote system (e.g. a further processor-controlled device), a characteristic associated with a device involved in an interaction with the data, such as encryption or decryption of the data. In this way, the identity of the device involved in the interaction can be identified. For example, the characteristic may be obtained by another device or system than that involved in the interaction, e.g. a remote system, in response to identifying that the interaction is malicious in nature. Mitigating action can then be taken to mitigate the effect of the malicious behaviour performed by the device.

Each feature disclosed herein, and (where appropriate) as part of the claims and drawings may be provided independently or in any appropriate combination. Any apparatus feature may also be provided as a corresponding step of a method, and vice versa.

In general, it is noted herein that while the above describes examples, there are several variations and modifications which may be made to the described examples without departing from the scope of the appended claims. One skilled in the art will recognise modifications to the described examples.

Any reference numerals appearing in the claims are for illustration only and shall not limit the scope of the claims. As used throughout, the word ‘or’ can be interpreted in the exclusive and/or inclusive sense, unless otherwise specified.

1. A method comprising, at a processor-controlled device:
obtaining encrypted data comprising an encrypted data portion;
obtaining an identifier indicative of a characteristic associated with the processor-controlled device; and
performing a decryption process comprising:
decrypting the encrypted data portion to generate a decrypted data portion; and
generating decrypted data comprising the decrypted data portion and an identifying portion based on the identifier.

2. The method of claim 1, wherein the encrypted data is indicative of at least one previous interaction with the encrypted data portion and/or an unencrypted version of the encrypted data portion.

3. The method of claim 2, wherein the at least one previous interaction comprises a previous decryption of the encrypted data portion by a further processor-controlled device.

4. The method of claim 2, wherein the at least one previous interaction comprises a previous generation of the unencrypted version of the encrypted data portion by a sensor device.

5. The method of claim 2, comprising:
decrypting at least a portion of the encrypted data to obtain at least one further identifier associated with the at least one previous interaction; and
generating the identifying portion, comprising processing the identifier and the at least one further identifier using a one-way cryptographic function.

6. The method of claim 2, comprising:
decrypting at least a portion of the encrypted data to obtain at least one further identifier associated with the at least one previous interaction; and
generating the identifying portion, wherein the identifying portion comprises the identifier and the at least one further identifier.

7. The method of claim 5, comprising using a further identifier of the at least one further identifier to obtain, from storage of the processor-controlled device or a remote system, a characteristic associated with a device involved in a previous interaction of the at least one previous interaction, wherein optionally the method comprises obtaining the characteristic associated with the device in response to a determination that the previous interaction is indicative of malicious behaviour.

8. The method of claim 1, wherein decrypting the encrypted data portion comprises decrypting the encrypted data portion using a key based on at least part of an unencrypted version of the encrypted data.

9. The method of claim 1, comprising encrypting the decrypted data using a key based on at least part of the decrypted data to obtain re-encrypted data, and optionally sending the re-encrypted data to a further processor-controlled device.

10. The method of claim 1, wherein the decryption process is performed using an application of the processor-controlled device.

11. The method of claim 10, wherein decrypting the encrypted data portion comprises decrypting the encrypted data portion using an application key associated with the application.

12. The method of claim 11, comprising encrypting the decrypted data using the application key.

13. The method of claim 11, wherein decrypting the encrypted data portion comprises decrypting the encrypted data portion using a combined key based on a combination of the application key and the key based on at least part of the unencrypted version of the encrypted data.

14. The method of claim 11, comprising encrypting the decrypted data using a combined key based on a combination of the application key and the key based on at least part of the decrypted data.

15. The method of claim 1, wherein obtaining the identifier comprises processing characteristic data indicative of the characteristic using a one-way cryptographic function to generate the identifier.

16. The method of claim 1, wherein the identifier is further indicative of a characteristic associated with the encrypted data portion.

17. A method comprising, at a processor-controlled device:
obtaining sensitive data;
generating an identifier indicative of a characteristic associated with the processor-controlled device and/or a further processor-controlled device that previously interacted with the sensitive data; and
performing an encryption process comprising generating encrypted data from which the identifier is derivable, the encrypted data comprising an encrypted data portion representative of the sensitive data.

18. The method of claim 17, wherein the sensitive data comprises an identifying portion indicative of at least one further previous interaction with the sensitive data and/or an encrypted version of the sensitive data.

19. The method of claim 17, wherein generating the encrypted data comprises generating the encrypted data using a key based on the sensitive data.

20. The method of claim 17, wherein the encryption process is performed using an application of the processor-controlled device.

21. The method of claim 20, wherein generating the encrypted data comprises generating the encrypted data using an application key associated with the application.

22. The method of claim 21, wherein generating the encrypted data comprises generating the encrypted data using a combined key based on a combination of the application key and the key based on the sensitive data.

23. The method of claim 17, wherein generating the identifier comprises processing characteristic data indicative of the characteristic using a one-way cryptographic function.

24. A processor-controlled device comprising at least one processor and storage comprising computer program instructions which, when processed by the at least one processor, cause the processor-controlled device to perform the method of claim 1.

25. A network comprising the processor-controlled device of claim 24.
